(19) United States
(12) Patent Application Publication
(10) Pub. No.: US 2010/0287163 A1
(43) Pub. Date: Nov. 11, 2010

(54) COLLABORATIVE ONLINE CONTENT EDITING AND APPROVAL

(76) Inventors: G. S. Sridhar, Bangalore (IN); Vishwanath Ramdas, Bangalore (IN); Pradeep Bennur Teregowda, Bangalore (IN)

Correspondence Address: EVERGREEN VALLEY LAW GROUP, 4 N 2nd Street, Suite 598, SAN JOSE, CA, 95113, US

(21) Appl. No.: 12/525,552

(22) PCT Filed: Jan. 3, 2008
(86) PCT No.: PCT/US08/00066

§ 371 Date: Dec. 1, 2009

(30) Foreign Application Priority Data
Feb. 1, 2007 (IN) 236/CHE/2007

(51) Int. Cl. G06F 17/30

(52) U.S. Cl. 707/740; 707/737; 707/802; 707/E17.089; 707/E17.044; 707/748

(57) ABSTRACT

A collaborative online content editing and approval system for creating an automated workflow process for editing and approving content before displaying in public domain. Content and data document including information of the content is received. Content and information of the content is then compared with editor information for selecting an editor. Further, a selected editor is automatically alerted to participate in the online content editing.

### BACKGROUND

1. Technical Field

Embodiments of the invention generally relate to online content editing and more particularly to an automated workflow process in collaborative online content editing.

2. Prior Art

With the proliferation of internet and digital networks, automated workflow mechanisms have become increasingly popular. Collaborative content editing is one such workflow mechanism used in editorial processes and various document management systems. These workflow mechanisms create communities of practice which includes informal networks of people who share common objectives, interests or solutions.

Collaboration content editing techniques allow people (editors) to share expertise to edit and approve content before publishing in public domain for public consumption. Typically, in content editing systems, content is uploaded for editing and approval in a small network, for example, an intranet which includes known individuals to edit and approve the content. These systems are designed for a small private group of individuals who either locally or being dispersed collaboratively for content editing and approval.

The above systems become inefficient when the content has to be globally distributed over wide geographical area. If the content has to be globally distributed, editors of respective geographical locations should be selected for content editing to maintain efficiency. For example, an editor in the United States of America may not be familiar with language or culture of India to approve a content which has to be deployed in India. Also, there may be content restrictions in various geographical locations and target groups for contents may differ within the geographical location. Existing content editing systems fall short of performance in selecting editors when the content has to be globally distributed, outside of the local network of the content editing system.

Further, ensuring and maintaining high quality and validity of the approved content is of prime importance in content editing systems. Some existing content editing systems allow anyone to edit content which may result in easily vandalized or susceptible to unchecked and false information. These content editing systems become incompetent in selecting and evaluating editors based on their skills and experience. Also, there exist no ways to ensure the quality of editors and assign the job to efficient editors.

In light of the foregoing discussions, there is a need for creating an efficient automated workflow process to qualify and approve contents before displaying in public domain.

### SUMMARY

Embodiments of the invention described herein provide collaborative online content editing methods and system for editing and approving contents before displaying in public domain.

An exemplary embodiment of the invention provides an automated workflow method for editing and approving content before displaying in public domain. Content and data document including information of the content is received. Content and information of the content is then compared with editor information for selecting an editor. Editor information includes classification of the editor based on location and domain skills. Further, a selected editor is automatically alerted to participate in the online content editing.

An exemplary embodiment of the invention provides a system for editing and approving content before displaying in public domain. The system includes a content receiving module for receiving content and a data document including information of the content; and a comparing module for comparing the content and information of the content with editor information for selecting an editor.

An exemplary embodiment of the invention provides a method for rating and dynamically rewarding editors. A content editing project is assigned to a set of editors. After receiving the editorial approval from the set of editors, content is rated based on the editorial approval and category of the set of editor. Editorial approval from each of the set of editors is compared with the rating of the content and each of the set of editors is then re-rated. Further, each of the set of editors is re-categorized based on a current editor rating.

An exemplary embodiment of the invention provides an automated workflow method for editing and approving content where a service provider receives content and data document including information of the content from a content provider. Content and information of the content is then compared with editor information for selecting an editor. Editor information includes classification of the editor based on location and domain skills. Further, a selected editor is automatically alerted to participate in the online content editing.

An exemplary embodiment of the invention provides a machine-readable medium product for editing and approving content before displaying in public domain. The machine-readable medium product includes instructions operable to cause a programmable processor to perform receiving a content and data document including information of the content; and comparing the content and information of the content with an editor information for selecting an editor, the editor information comprising classification of the editor according to a set of rules.

Other aspects and example embodiments are provided in the Figures and the Detailed Description that follows.

### BRIEF DESCRIPTION OF THE DRAWINGS

FIG. 1 is a flow diagram illustrating steps in a method for selecting multiple editors according to an embodiment of the invention;

FIG. 2 is a flow diagram illustrating steps in the method for rating editors according to an embodiment of the invention;

FIG. 3 is a block diagram illustrating an exemplary implementation of a content editing system according to an embodiment of the invention;

FIG. 4-FIG. 6 are screen shots illustrating various functionalities of the Graphical User Interface (GUI) according to an embodiment of the invention; and

FIG. 7 is a block diagram of an exemplary computer system upon which embodiments of the invention may be implemented.

### DETAILED DESCRIPTION OF THE EMBODIMENTS

Embodiments of the invention create an automated workflow process to edit and approve content before publishing in public domain for public consumption by selecting a set of editors to edit and approve the content. Automated workflow process includes inbuilt capabilities for globally distributing the content according to varied standards of publishing and censoring without imposing extra stringency or dilution of the standards of the respective places of publication. Embodiments of the invention also provide a set of applications including a mechanism for ensuring performance and abilities of editors, time efficient content editing, and dynamic reward and penalty system for editors.

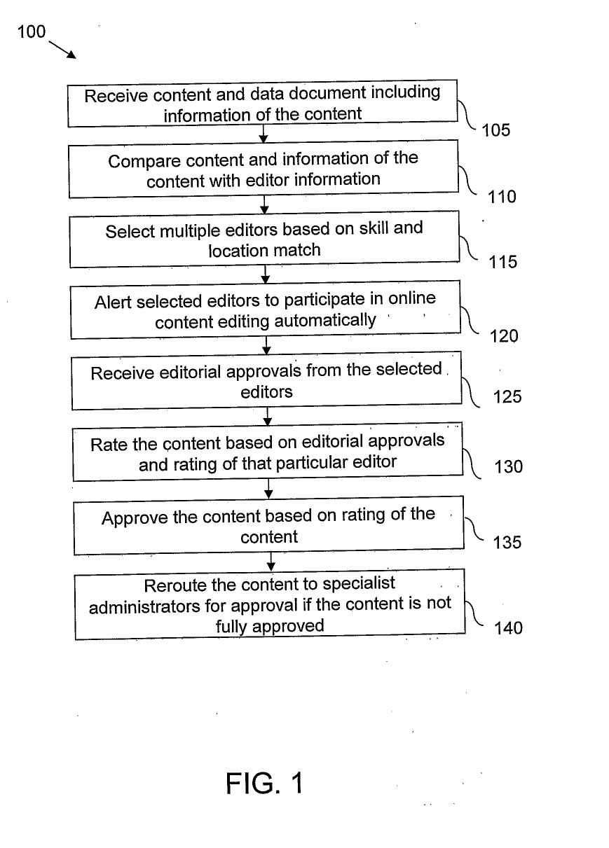

FIG. 1 is a flow diagram 100 illustrating steps in a method for selecting multiple editors according to an embodiment of the invention. In an embodiment of the invention, a service provider performs the steps illustrated in FIG. 1. At step 105, content for editing is received along with a data document including information of the content from a content provider. A data document includes deployment location, deployment scheme and target audience of the content. Deployment scheme includes rules set by the content providers for publishing the content. In an embodiment of the invention, content includes multimedia packages having a combination of media and text under sub-frames which are displayed together which needs to be approved before publication. In another embodiment of the invention, content includes a video, text or an image. In yet another embodiment of the invention, content includes an online document which needs to be edited before publication. Embodiments of the invention have been explained using multimedia packages as an example of content where approval from the editors are required before publishing the content. However, it will be appreciated that embodiments of the invention can be applied in editing of an online document before publication.

Further, information contained in the data document is compared with deployment scheme (deployment location, deployment scheme and target audience of the content) and all available unique geographic locations with respect to editing policies to create unique combinations of content and location information. Characterization information around each unique combination inherited from the content and the geographic location or deployment scheme is then provided. This characterization information is compared with editor information at step 110. In an embodiment of the invention, the editor information includes classification of each editor according to a set of criteria, for example, background, language skills, domain skills, profession, location, age, and gender of the editor. Editors are classified into various categories and each category is given points. Editors are classified during registration and empanelment.

At step 115, multiple editors are selected based on point system which includes skill and location match of the editor with the characterization information. A minimum and maximum threshold numbers of editors allowed to participate in the online content editing are predefined. At step 120, selected editors are automatically alerted to participate in the online content editing. In an embodiment of the invention, editors are alerted through communication means which include but not limited to, Short Service Message (SMS), electronic mail and various onscreen communication channels. Further, editors accept the online content editing project and at step 125, the editorial approvals from the selected editors are received. If a selected editor does not accept the invitation to participate in the online content editing within a predefined time period, steps 115 and 120 are repeated till the minimum threshold number of editors are selected for the online content editing. In one embodiment of the invention, the editor can contact specialist administrators if they have any query regarding the content. At step 130, the content is rated based on internal point logic. Internal point logic calculates points based on an editor's category (more points for a higher category), current rating, profile, test scores and also editorial approval from that particular editor. Majority of editorial approvals from various editors are also calculated to rate the content.

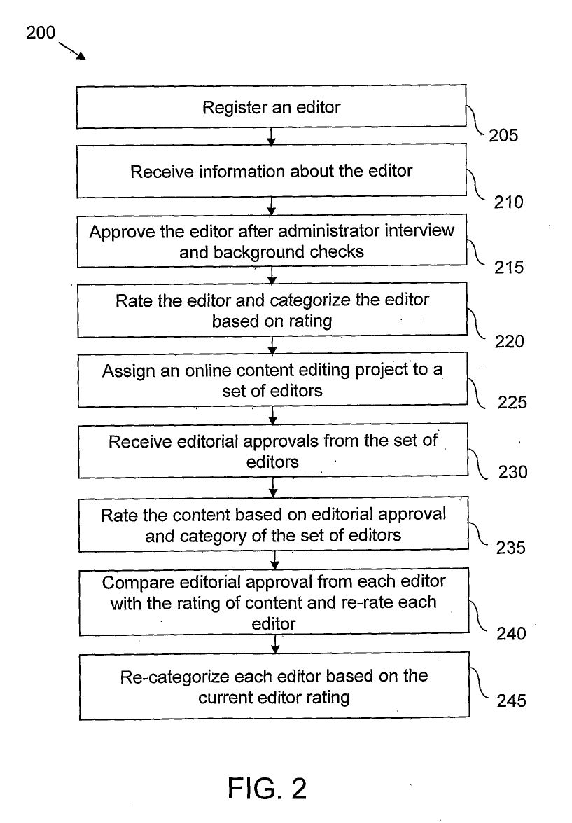

At step 135, the content is approved based on the rating of the content. If the rating of the content is above a predetermined threshold rating, the administrator is alerted and the content is sent to an internal team. The internal team then performs an administrative review and finalizes the content approval. On the other hand, if content is not fully approved by the editor, at step 140, the content is rerouted to specialist administrators for approval. After the approval process is completed, the content is approved and permitted, or blocked according to administrator reviews and approval stages. Further, the content author is alerted on the status of the content. An embodiment of the invention provided in FIG. 2 socially involves skilled editors to participate in approving content as freelancers without being physically or organizationally present.

An embodiment of the invention provides a method to assure content editing and approval within a certain time frame. A document is maintained in a database which includes time of content being provided for editing and approval. Based on time and rating of the content, an alert is automatically sent to internal administrators to initiate the content editing and approval process if the process is not already started. In such a way editorial content can be managed quickly and efficiently at very low cost of processing.

FIG. 2 is a flow diagram 200 illustrating steps in the method for rating editors according to an embodiment of the invention. At step 205, an editor is registered with the online editing system. Editor registers to the system and the user identification and password is confirmed. Further, at step 210, basic information about the editor is received. In an embodiment of the invention, basic information about the editor includes, but not limited to, name, electronic mail address, age, gender, address, domain skills, profession, resume and language skills. At step 215, the editor is approved or rejected after an administrator interview and background checks. If the administrator approves, the editor is upgraded according to various standards and will be categorized into different groups. If the editor is rejected by the administrator, he/she is eventually deleted from the content editing system after degrading into lower level categories through another set of administrator reviews.

In an embodiment of the invention, an automated empanelment and testing of newly registered editors is performed to validate the editors. Each editor, after registration is permitted to participate in the online content editing after initial verification by the administrator. All editors undergoing training and testing are selected in random based on their proffered language and domain skills for participating in the online content editing. After administrator approval, at step 220, the editor is rated and further categorized based on rating. Approval of an editor is not considered for evaluating the content, until the editor comes under a certified category. Various categories in an embodiment of the invention include, for example, felon, quarantined, friend and fellow, each having a point limit set by the administrator.

An embodiment of the invention provides a mechanism for re-rating the editors based on their performance in the online content editing and approval thereby ensuring high quality and validity of the approved content. At step 225, an online content editing project is assigned to a set of editors. Editors review the content and provide their approvals or edits. At step 230, editorial approvals from the set of editors are received. Further, at step 235, the content is rated based on majority of editorial approvals from various editors and category of each editor who provided the approval.

The editorial approval from each editor is compared with a final rating obtained on the content and each editor is given points at step 240. Editor rating calculations are performed at this stage based on various standards including, for example, time taken for editing, base editing amount, number of invitees, and number of editors. At step 245, each editor is re-categorized based on current rating of the editor. At threshold levels of points, editors are moved to a higher or lower category. In this manner, embodiments of the invention provide a self correcting and learning mechanism for rating editors based on performance and transactions.

Further, an embodiment of the invention provides a dynamic reward and penalty mechanism for editors participated in the online content editing. Editors are eligible for an invite amount if invited, and for a base amount if participated in editing. The income is shared for editorial of each content based on different editor categories and also multiple dimensions, for example, time of action of editor on the content, accuracy with respect to final outcome, and category of the editor to share the rewards with each editor. For example, the editor gets +25 points on approval of the edited content and gets −5 points for a wrong assignment or for not participating when invited for editing.

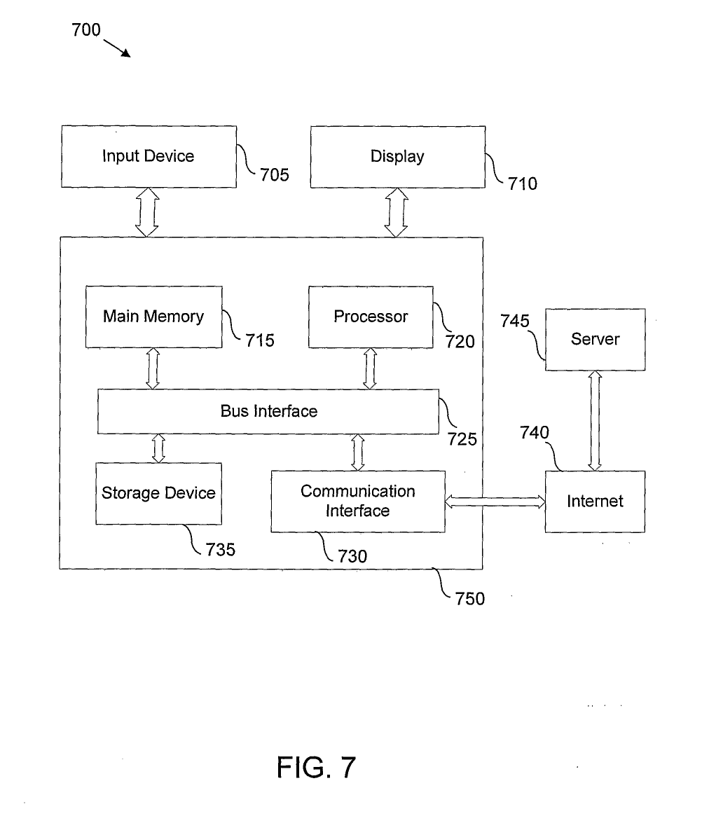

One or more steps of the method described in FIG. 1 and FIG. 2 may be implemented using a computer system. The computer system is explained in details in conjunction with FIG. 7.

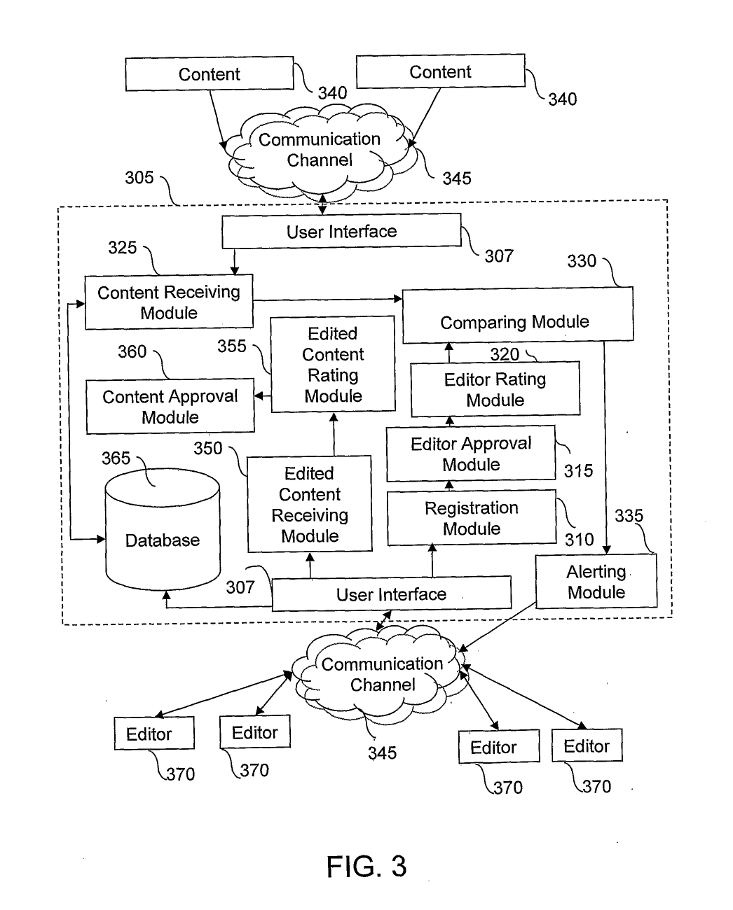

FIG. 3 is a block diagram illustrating an exemplary implementation of a content editing system 305 according to an embodiment of the invention. The block diagram includes a set of editors 370 interacting with the content editing system 305 via a communication channel 345. The content editing system includes a user interface 307, a registration module 310, an editor approval module 315, an editor rating module 320, a content receiving module 325, a comparing module 330, an alerting module 335, an edited content receiving module 350, an edited content rating module 355, a content approval module 360 and a database 365.

The registration module 310 registers a set of editors 370 with the content editing system 305. In an embodiment of the invention, the registration module 310 receives basic information about editors 370 which includes but not limited to, name, e-mail address, age, gender, address, domain skills, profession, resume and language skills. Editor information is stored in a database 365. A user interface 307 is provided for the editors 370 to interact with content editing system 305. After registration, the editor approval module 315 approves the editor based on administrator interview and background checks. Further, the editor rating module 340 rates each editor during empanelment according to a set of criteria, for example, background, language skills, domain skills, profession, location, age, and gender of the editor. Editors are classified into various categories and each category is given points.

In an embodiment of the invention, a content author uploads a content 340 in the content editing system through a communication channel 310. An example of the communication channel 345 includes internet. A user interface 307 is provided for the content author to interact with the content editing system 305. Further, the content receiving module 325 receives the content along with the data document including information of the content and stores in the database 365. The data document includes deployment location, deployment scheme and target audience of the content. Comparing module 330 then compares the deployment scheme and all available unique geographic locations with respect to editing policies to create unique combinations using content and location information. Further, comparing module 330 compares such unique combinations with editor information and editor rating to select multiple editors 370 suitable for editing the content 340 based on point system as explained earlier.

After selecting multiple editors 370, alerting module 335 alerts the selected editors 370. In an embodiment of the invention, editors 37Q are alerted via communication means which include, but not limited to, Short Service Message (SMS), electronic mail and onscreen communication channels. Edited content receiving module 350 receives the edited content from the editors 370. Edited content rating module 355 rates the edited content based on internal point logic as explained earlier. Content approval module 360 approves the content 340 after internal reviews and administrator approvals.

Various modules in the content editing system 305 may include one or more algorithms.

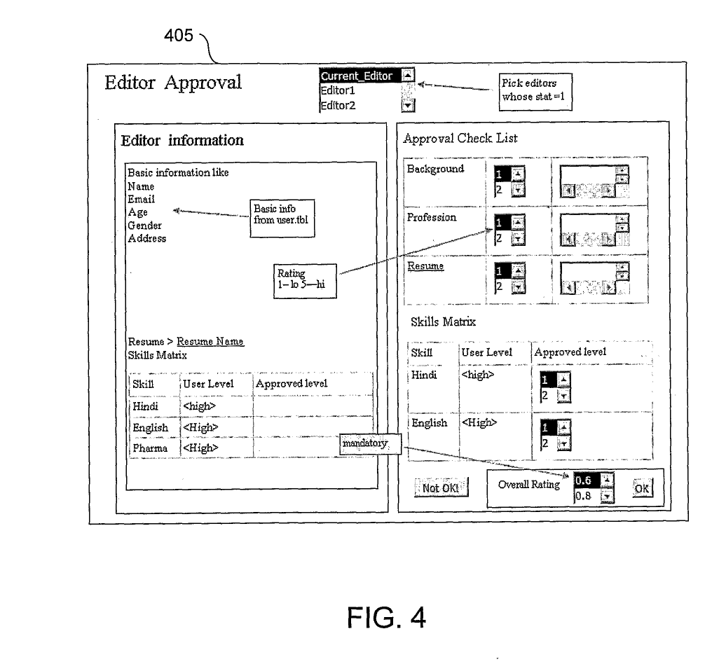

FIG. 4-FIG. 6 are screen shots 405-605 illustrating various functionalities of the Graphical User Interface (GUI) according to an embodiment of the invention. FIG. 4 illustrates an editorial approval screen 405 where an administrator can give an overall rating for an editor. Under ‘editorial information’ basic information of the editor is available. Under ‘approval checklist’ in the screen 405, administrator can rate the editor based on background, profession and resume. Under ‘skills matrix’ administrator can rate the editor based on language skills. If the ‘overall rating’ of an editor is above a predetermined rate, administrator approves the editor.

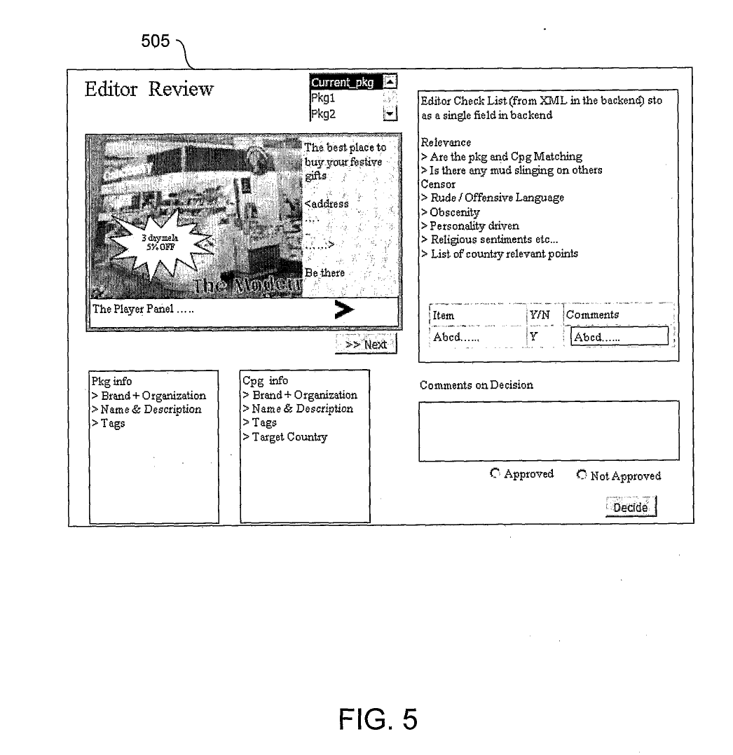

FIG. 5 illustrates an editor review screen 505. If the editor browses from an editor alert or a link, the editor review screen 505 is loaded with specific package details (‘pkg info’ in the screen 505). The content, for example a multimedia content, is displayed on the screen 505. After viewing, editor can click on ‘next’ tab to go to the checklist section. The checklist section includes, for example, match of the content with the location, relevancy, obscenity, offensive language, religious statements and list of country relevant points. Editor can provide his/her decision by clicking ‘approved’ or ‘not approved’ tabs and further provide comments on the decision.

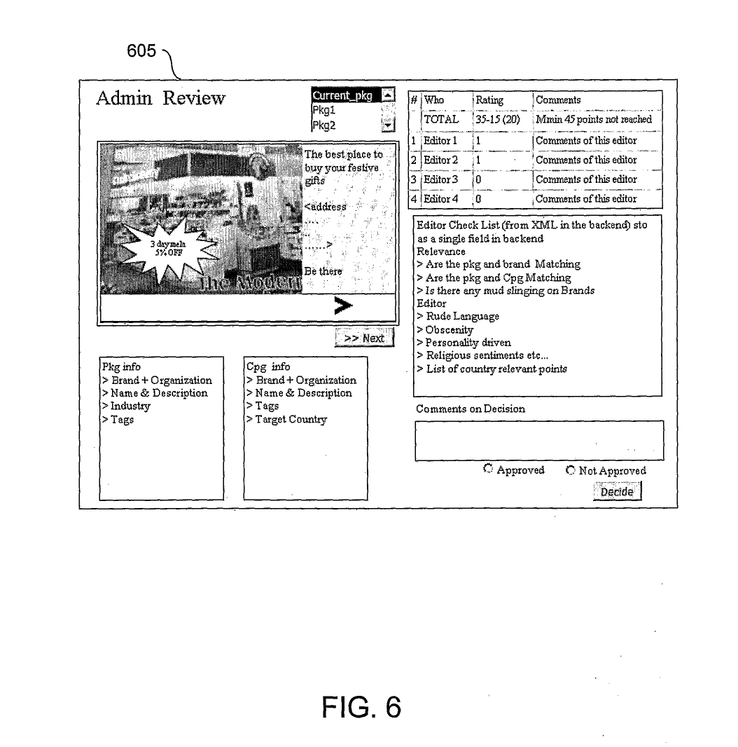

FIG. 6 illustrates an administrator review screen 605. Administrator can view editorial approvals of all editors in the screen 605 which includes editor rating and editor comments. Further, administrator can provide comments on editor decisions and provide final approval for the content by clicking ‘approved’ or ‘not approved’ tabs.

FIG. 7 is a block diagram of an exemplary computer system 700 upon which various embodiments of the invention may be implemented. Computer system 700 includes a processing unit 750 including a main memory 715, such as a Random Access Memory (RAM) or other dynamic storage device, coupled to a bus interface 725 for storing information and instructions to be executed by processor 720. A storage device 735, such as a magnetic disk or optical disk, is provided and coupled to bus interface 725 for storing information and instructions. Computer system 700 may be coupled via bus interface 725 to a display 710 for displaying information to a user. An input device 705, including alphanumeric and other keys, is coupled to bus interface 725 for communicating information and command selections to processor 720.

Embodiments of the invention are related to the use of computer system 700 for implementing the techniques described herein. According to one embodiment of the invention, those techniques are performed by computer system 700 in response to processor 720 executing one or more sequences of one or more instructions included in main memory 715. Such instructions may be read into main memory 715 from another machine-readable medium product, such as storage device 735. Execution of the sequences of instructions included in main memory 715 causes processor 720 to perform the method embodiment of the invention described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable medium product” as used herein refers to any medium that participates in providing data that causes a machine to operation in a specific fashion. Examples of the machine-readable medium product include but are not limited to memory devices, tapes, disks, cassettes, integrated circuits, servers, online software, download links, installation links, and online links.

In an embodiment implemented using computer system 700, various machine-readable medium products are involved, for example, in providing instructions to processor 720 for execution. Computer system 700 also includes a communication interface 730 coupled to bus interface 725. Communication interface 730 provides a two-way data communication coupling to internet 740 that is coupled a server 745. Server 745 might transmit a requested code for an application program through internet 740 and communication interface 730.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. An online content editing method comprising:
receiving a content and a data document comprising information of the content; and
comparing the content and information of the content with an editor information for selecting an editor, the editor information comprising classification of the editor according to a set of criteria.

2. The online content editing method of claim 1 further comprising:
alerting a selected editor to participate in the content editing automatically.

3. The online content editing method of claim 1, wherein receiving a data document comprising information of the content comprises:
receiving information comprising deployment location, deployment scheme and target audience of the content.

4. The online content editing method of claim 1, wherein comparing the content and information of the content with editor information comprises:
registering the editor after a set of initial checks; and
rating the editor based on a set of attributes and categorizing the editor based on the rating.

5. The online content editing method of claim 1 further comprising:
receiving editorial approval from the selected editor;
rating the content based on the editorial approval and rating of the selected editor; and
approving the content based on rating of the content.

6. The online content editing method of claim 5, wherein approving the content comprises:
rerouting the content to a specialist administrator for approval if the content is not completely approved by the editor.

7. The online content editing method of claim 1, wherein the alerting a selected editor comprises:
alerting the selected editor using onscreen communication means.

8. The online content editing method of claim 1, wherein classification of the editor based on a set of criteria comprises:
classifying based on background, language skills, domain skills, profession, location, age, and gender of the editor.

9. The online content editing method of claim 1, wherein the content comprises at least one of a multimedia content, video, text and image.

10. An online content editing system comprising:
a content receiving module for receiving a content and a data document comprising information of the content; and
a comparing module for comparing the content and information of the content with an editor information for selecting an editor, the editor information comprising classification of the editor according to a set of criteria.

11. The online content editing system of claim 10, wherein the content receiving module comprises:
a registration module for registering and testing the editor using a set of initial checks; and
an editor rating module for rating the editor based on a set of attributes and categorizing the editor based on the rating.

12. The online content editing system of claim 10 further comprising:
an alerting module for alerting a selected editor to participate in the online content editing automatically;
an edited content receiving module for receiving edited content from the selected editor;
a content rating module for rating the content based on approval from the selected editor and rating of the selected editor;
an approval module for approving the content based on rating of the content; and
a database for storing the content and the editor information.

13. An online content editing method comprising:
assigning an content editing project to a set of editors;
receiving editorial approval from the set of editors and rating the content based on the editorial approval and category of the set of editors;
comparing editorial approval from each of the set of editors with the rating of the content for re-rating each of the set of editors; and
re-categorizing each of the set of editors based on a current rating of each of the set of editors.

14. The online content editing method of claim 13 and further comprising, prior to assigning:
registering the set of editors after a set of initial checks, wherein the set of initial checks comprises an administrator interview and background checks; and
rating the editor based on a set of attributes and categorizing the editor based on the rating.

15. The online content editing method of claim 13, wherein re-categorizing each of the set of editors comprises:
re-categorizing each of the set of editors to a lower category for a wrong editorial approval and to a higher category for a correct editorial approval.

16. The online content editing method of claim 15, wherein re-categorizing comprises:
rewarding each of the set of editors based on re-categorizing.

17. A method for online content editing wherein a service provider performing:
receiving a content and a data document comprising information of the content from a content provider;
comparing the content and information of the content with an editor information for selecting an editor, the editor information comprising classification of the editor according to a set of criteria; and
alerting a selected editor to participate in the content editing automatically.

18. The method of claim 17, wherein comparing the content and information of the content with editor information comprises:
registering the editor with the service provider after a set of initial checks; and
rating the editor based on a set of attributes and categorizing the editor based on the rating.

19. The method of claim 17, wherein the service provider further performing:
receiving editorial approval from the selected editor;
rating the content based on the editorial approval and rating of the selected editor;
approving the content based on rating of the content; and
alerting the content provider on the status of the content.

20. A machine-readable medium product, comprising instructions operable to cause a programmable processor to perform:
receiving a content and a data document comprising information of the content; and
comparing the content and information of the content with an editor information for selecting an editor, the editor information comprising classification of the editor according to a set of criteria.

21. The machine-readable medium product of claim 20 further comprising instructions operable to cause a programmable processor to perform:
alerting a selected editor to participate in the online content editing automatically.

22. The machine-readable medium product of claim 20, wherein comparing the content and information of the content with editor information comprises:
registering the editor using a set of initial checks; and
rating the editor based on a set of attributes and categorizing the editor based on the rating.

23. The machine-readable medium product of claim 20 further comprising instructions operable to cause a programmable processor to perform:
receiving edited content from the selected editor;
rating the content based on approval from the selected editor and rating of the selected editor; and
approving the content based on rating of the content.

24. The machine-readable medium product of claim 23, wherein approving the content comprises:
rerouting the content to specialist administrators for approval if the content is not completely approved by the editor.
